(19) United States
(12) Patent Application Publication
(10) Pub. No.: US 2022/0101871 A1
(43) Pub. Date: Mar. 31, 2022

(54) LIVE STREAMING CONTROL METHOD AND APPARATUS, LIVE STREAMING DEVICE, AND STORAGE MEDIUM

(71) Applicant: GUANGZHOU HUYA INFORMATION TECHNOLOGY CO., LTD., Guangdong (CN)

(72) Inventors: Zihao Xu, Guangdong (CN); Hao WU, Guangdong (CN); Mingshen Ma, Guangdong (CN); Zheng Li, Guangdong (CN); Zhiying Zhou, Guangdong (CN)

(21) Appl. No.: 17/598,768

(22) PCT Filed: Mar. 27, 2020
(86) PCT No.: PCT/CN2020/081626

§ 371 Date: Oct. 20, 2021

(30) Foreign Application Priority Data
Mar. 29, 2019 (CN) 201910250929.2
Mar. 29, 2019 (CN) 201910252003.7

(51) Int. Cl. G10L 21/10; G10L 25/63; G10L 15/04

(52) U.S. Cl. CPC G10L 21/10; G10L 2021/105; G10L 15/04; G10L 25/63

(57) ABSTRACT

Embodiments of the present application relate to the technical field of Internet, and provide a live streaming control method and apparatus, a live streaming device, and a storage medium. Voice information of a live streamer is obtained, and the voice information is analyzed and processed, so that according to the processing result, a virtual image in a live streaming screen is controlled to execute an action matching the voice information, so as to improve the precision of controlling the virtual image and enable the virtual image in the live streaming screen and the live streaming content of the live streamer to have a high matching degree.

### CROSS-REFERENCE TO RELATED APPLICATIONS

The present application claims priority to Chinese Patent Application No. 201910250929.2, entitled “Live Streaming Control Method and Apparatus, Live Streaming Device, and Readable Storage Medium”, filed with Chinese Patent Office on Mar. 29, 2019, and Chinese Patent Application No. 201910252003.7, entitled “Virtual Image Control Method, Virtual Image Control Apparatus, and Electronic Device”, filed with Chinese Patent Office on Mar. 29, 2019, the entire contents of which are incorporated herein by reference.

### TECHNICAL FIELD

The present application relates to the technical field of Internet, and particularly provides a live streaming control method and apparatus, a live streaming device, and a storage medium.

### BACKGROUND ART

With a rapid development of an Internet technology, live streaming becomes a popular network interaction mode. An anchor may perform live streaming by an electronic device, and an audience may watch live streaming by an electronic device.

In some live streaming schemes, in order to increase an interestingness of live streaming and meet a requirement that some anchors are unwilling to appear in live streaming pictures, a virtual image of the anchor may be displayed in the live streaming picture, and the anchor may interact with the audience by means of the virtual image. However, in some other schemes in which the virtual image is used for live streaming, the virtual image has a single control mode.

### SUMMARY

An object of the present application is to provide a live streaming control method and apparatus, a live streaming device, and a storage medium, which enable a virtual image in a live streaming picture and a live streaming content of an anchor to have a higher matching degree.

To achieve at least one of the above-mentioned objects, the present application adopts the technical solution as follows.

Embodiments of the present application provide a live streaming control method, applicable to a live streaming device, the method including:

obtaining voice information of an anchor;

extracting keywords and sound feature information from the voice information;

determining a current emotional state of the anchor according to the extracted keywords and the extracted sound feature information;

obtaining, by matching, from a pre-stored action instruction set, a corresponding target action instruction according to the current emotional state and the keywords; and

executing the target action instruction, and controlling a virtual image in a live streaming picture to execute an action corresponding to the target action instruction.

Optionally, as a possible implementation, the pre-stored action instruction set includes a general instruction set and a customized instruction set corresponding to the current virtual image of the anchor, wherein the general instruction set stores general action instructions configured to control each virtual image, and the customized instruction set stores customized action instructions configured to control the current virtual image.

Optionally, as a possible implementation, the step of matching, from a pre-stored action instruction set, an action instruction according to the current emotional state and the keywords includes:

in a case where a first action instruction associated with the current emotional state and the keywords exists in the pre-stored action instruction set, taking the first action instruction as the target action instruction;

in a case where the first action instruction does not exist in the pre-stored action instruction set, obtaining, from the pre-stored action instruction set, a second action instruction corresponding to the current emotional state and a third action instruction associated with the keywords; and

determining the target action instruction according to the second action instruction and the third action instruction.

Optionally, as a possible implementation, the step of determining the target action instruction according to the second action instruction and the third action instruction includes:

detecting whether the second action instruction and the third action instruction have a linkage relationship, wherein if the linkage relationship exists, the second action instruction and the third action instruction are combined according to an action execution sequence indicated by the linkage relationship, to obtain the target action instruction; and

if the linkage relationship does not exist, one of the second action instruction and the third action instruction is selected as the target action instruction according to respective preset priorities of the second action instruction and the third action instruction.

Optionally, as a possible implementation, the method further includes:

for each keyword extracted from the voice information, counting a number of pieces of target voice information containing the keyword, as well as a first number of target action instructions determined according to a first number of pieces of newly obtained target voice information; and

if the number of the pieces of target voice information reaches a second number and the first number of target action instructions are same instruction, caching a corresponding relationship between the keyword and the same instruction in a memory of the live streaming device, wherein the first number does not exceed the second number; and

the step of matching, from a pre-stored action instruction set, an action instruction according to the current emotional state and the keywords includes:

searching from the cached corresponding relationships to judge whether there exists a corresponding relationship hit by the keyword, wherein

if yes, an instruction recorded in the hit corresponding relationship is determined as the target action instruction; and

if no, the step of matching, from a pre-stored action instruction set, an action instruction according to the current emotional state and the keywords is executed again.

Optionally, as a possible implementation, the method further includes:

emptying the corresponding relationship cached in the memory every first preset duration.

Optionally, as a possible implementation, for each action instruction in the pre-stored action instruction set, the live streaming device records a latest execution time of the action instruction; and

the step of executing the target action instruction includes:

obtaining a current time, and judging whether an interval between the current time and the latest execution time of the target action instruction exceeds a second preset duration, wherein

if the second preset duration is exceeded, the target action instruction is executed again; and

if the second preset duration is not exceeded, the pre-stored action instruction set is searched for other action instructions having an approximate relationship with the target action instruction, to replace the target action instruction, and the replaced target action instruction is executed.

Embodiments of the present application further provide a live streaming control method, applicable to a live streaming device, the live streaming device being configured to control a virtual image displayed in a live streaming picture, the method including:

obtaining voice information of an anchor;

performing voice analysis treatment on the voice information to obtain a corresponding voice parameter; and

converting the voice parameter into a control parameter according to a preset parameter conversion algorithm, and controlling a mouth shape of the virtual image according to the control parameter.

Optionally, as a possible implementation, the step of performing voice analysis treatment on the voice information to obtain a corresponding voice parameter includes:

segmenting the voice information, and extracting a voice segment within a set duration in each voice information segment after segmenting; and

performing voice analysis treatment on each extracted voice segment to obtain the voice parameter corresponding to each voice segment.

Optionally, as a possible implementation, the step of segmenting the voice information, and extracting a voice segment within a set duration in each voice information segment after segmenting includes:

extracting the voice segments within the set duration in the voice information at intervals of the set duration.

Optionally, as a possible implementation, the step of segmenting the voice information, and extracting a voice segment within a set duration in each voice information segment after segmenting includes:

segmenting the voice information according to continuity of the voice information, and extracting the voice segment within the set duration in each voice information segment after segmenting.

Optionally, as a possible implementation, the step of performing voice analysis treatment on each extracted voice segment to obtain the voice parameter corresponding to each voice segment includes:

extracting amplitude information of each voice segment; and

calculating the voice parameter corresponding to each voice segment according to the amplitude information of each voice segment.

Optionally, as a possible implementation, the step of calculating the voice parameter corresponding to the voice segment according to the amplitude information of the voice segment includes:

performing a calculation according to frame length information and the amplitude information of the voice segment using a normalization algorithm, to obtain the voice parameter corresponding to the voice segment.

Optionally, as a possible implementation, the control parameter includes at least one of lip spacing between upper and lower lips and a mouth corner angle of the virtual image.

Optionally, as a possible implementation, when the control parameter includes the lip spacing, the lip spacing is calculated according to the voice parameter and preset maximum lip spacing corresponding to the virtual image using the preset parameter conversion algorithm; and

when the control parameter includes the mouth corner angle, the mouth corner angle is calculated according to the voice parameter and a preset maximum mouth corner angle corresponding to the virtual image using the preset parameter conversion algorithm.

Optionally, as a possible implementation, when the control parameter includes the lip spacing, the maximum lip spacing is set according to pre-obtained lip spacing of the anchor; and

when the control parameter includes the mouth corner angle, the maximum mouth corner angle is set according to the pre-obtained mouth corner angle of the anchor.

Embodiments of the present application further provide a live streaming control method, applicable to a live streaming device, the method including:

obtaining voice information of an anchor;

extracting keywords and sound feature information from the voice information;

determining a current emotional state of the anchor according to the extracted keywords and the extracted sound feature information;

obtaining, by matching, from a pre-stored action instruction set, a corresponding target action instruction according to the current emotional state and the keywords;

executing the target action instruction, and controlling a virtual image in a live streaming picture to execute an action corresponding to the target action instruction;

performing voice analysis treatment on the voice information to obtain a corresponding voice parameter; and

converting the voice parameter into a control parameter according to a preset parameter conversion algorithm, and controlling a mouth shape of the virtual image according to the control parameter.

Embodiments of the present application further provide a live streaming device, including a memory, a processor and machine executable instructions stored in the memory and executed in the processor, wherein the machine executable instructions, when executed by the processor, implement the above-mentioned live streaming control method.

Embodiments of the present application further provide a readable storage medium, having machine executable instructions stored thereon, wherein the machine executable instructions, when executed, implement the above-mentioned live streaming control method.

### BRIEF DESCRIPTION OF DRAWINGS

FIG. 1 is a schematic frame diagram of a live streaming system according to an embodiment of the present application;

FIG. 2 is a schematic diagram of a live streaming interface according to an embodiment of the present application;

FIG. 3 is a schematic block diagram of a live streaming device according to an embodiment of the present application;

FIG. 4 is a schematic flow chart of a live streaming control method according to an embodiment of the present application;

FIG. 5 is a schematic diagram of substeps of step 207 in FIG. 4;

FIG. 6 is another schematic diagram of the substeps of step 207 in FIG. 4;

FIG. 7 is a schematic diagram of substeps of step 207-9 in FIG. 6;

FIG. 8 is another schematic flow chart of the live streaming control method according to the embodiment of the present application;

FIG. 9 is a schematic flow chart of substeps included in step 303 of FIG. 8;

FIG. 10 is a schematic flow chart of substeps included in step 303-3 of FIG. 9;

FIG. 11 is a schematic diagram of 20-frame voice data according to an embodiment of the present application; and

FIG. 12 is a schematic diagram of lip spacing and a mouth corner angle of a virtual image according to an embodiment of the present application.

In the drawings, 11—live streaming server; 12—first terminal device; 13—second terminal device; 100—live streaming device; 110: memory; 120—processor.

### DETAILED DESCRIPTION OF EMBODIMENTS

To make the objectives, technical solutions and effects of the embodiments of the present application clearer, the technical solutions in the embodiments of the present application are clearly and completely described below with reference to the accompanying drawings in the embodiments of the present application, and apparently, the described embodiments are not all but a part of the embodiments of the present application. Generally, the components of the embodiments of the present application described and illustrated in the drawings herein may be arranged and designed in a variety of different configurations.

Accordingly, the following detailed description of the embodiments of the present application provided in the drawings is not intended to limit the scope of protection of the present application, but only represents some selected embodiments of the present application. All other embodiments obtained by a person of ordinary skill in the art based on the embodiments of the present application without inventive efforts shall fall within the protection scope of the present application.

It should be noted that similar reference signs and letters denote similar items in the following drawings. Therefore, once a certain item is defined in one figure, it does not need to be further defined and explained in the subsequent figures.

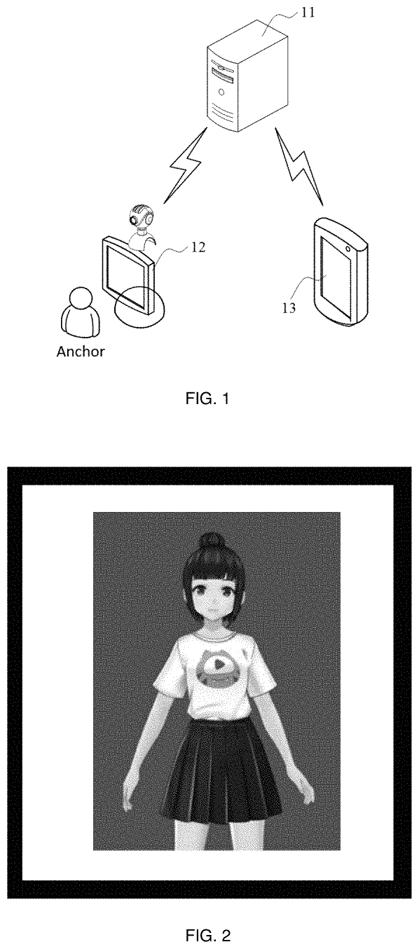

Referring to FIG. 1, FIG. 1 is a schematic diagram of a live streaming system according to an embodiment of the present application. The live streaming system may include a live streaming server 11 and a terminal device which are communicatively connected through a network. In the above, the terminal device may be, but is not limited to, a smart phone, a personal digital assistant, a tablet computer, a personal computer (PC), a notebook computer, a virtual reality terminal, an augmented reality terminal, or the like.

In some possible embodiments, the terminal device and the live streaming server 11 may have various communication modes. For example, a client (for example, an application) may be installed in the terminal device, and the client may be in communication with the live streaming server 11 to use live streaming service provided by the live streaming server 11.

For another example, the terminal device may establish a communication connection with the live streaming server 11 through a program running in a third-party application, so as to use the live streaming service provided by the live streaming server.

For yet another example, the terminal device may log in to the live streaming server 11 through a browser, so as to use the live streaming service provided by the live streaming server 11.

In a possible embodiment, depending on users, the terminal devices may be divided into a first terminal device 12 on the anchor side and a second terminal device 13 on the audience side. It should be noted that the first terminal device 12 may also serve as the second terminal device 13 when the user of the first terminal device 12 changes from the anchor to the audience, and the second terminal device 13 may also serve as the first terminal device 12 when the user of the second terminal device 13 changes from the audience to the anchor.

In the above, the first terminal device 12 may be provided with an audio acquisition device which may be configured to acquire voice information of the anchor. The audio acquisition device may be built in the first terminal device 12, or may be externally connected to the first terminal device 12, and the configuration mode of the audio acquisition device is not limited in the embodiment of the present application.

In a possible scenario, when the anchor uses a virtual image for live streaming, the first terminal device 12 may generate a video stream according to the virtual image and the collected voice information, and send the video stream to the live streaming server 11, and then the video stream is sent to the second terminal device 13 by the live streaming server 11, so as to implement live streaming based on the virtual image (as shown in FIG. 2).

In another possible scenario, the first terminal device 12 may directly send the collected voice information to the live streaming server 11, and the live streaming server 11 generates a video stream according to the virtual image and the voice information, and sends the video stream to the second terminal device 13, so as to implement live streaming based on the virtual image.

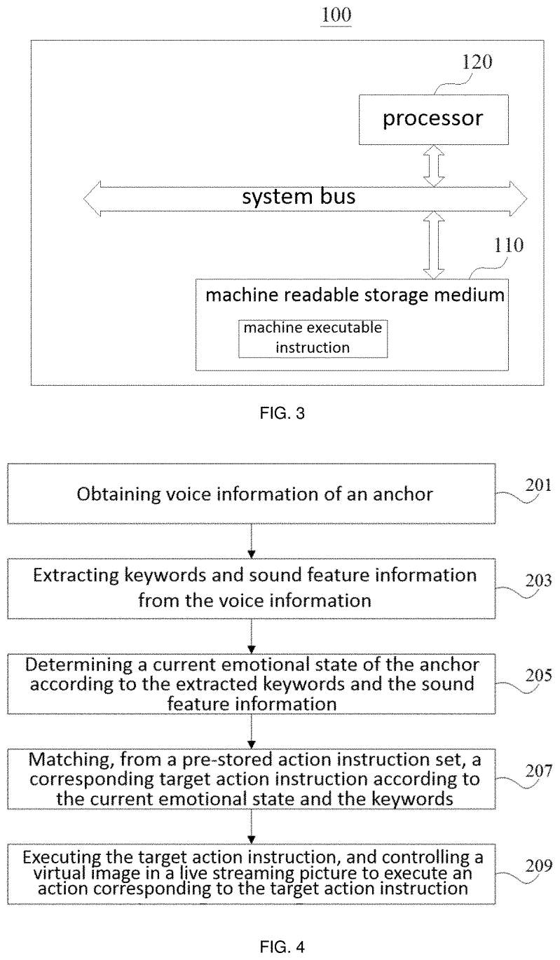

Referring to FIG. 3, FIG. 3 is a schematic block diagram of a live streaming device 100 according to an embodiment of the present application, and in some possible embodiments, the live streaming device 100 may be the live streaming server 11 or the first terminal device 12 shown in FIG. 1. The live streaming device 100 may include a memory 110 and a processor 120, and the memory 110 and the processor 120 may be connected to each other through a system bus to realize data transmission. The memory 110 may store machine executable instructions, and the processor 120 may implement a live streaming control method described below in the embodiment of the present application by reading and executing the machine executable instructions.

It should be noted that the structure shown in FIG. 3 is merely an illustration. The live streaming device 100 may also include components more or fewer than components shown in FIG. 3, for example, when the live streaming device 100 is the first terminal device 12, the live streaming device 100 further includes the above-mentioned audio acquisition device. Or, the live streaming device 100 may have a configuration completely different from that shown in FIG. 3.

Referring to FIG. 4, FIG. 4 is a schematic flow chart of a live streaming control method according to an embodiment of the present application, and the live streaming control method may be executed by the live streaming device 100 shown in FIG. 3. Steps of the live streaming control method are schematically described below.

Step 201: obtaining voice information of an anchor.

In some possible embodiments, when the live streaming device 100 is, for example, the first terminal device 12 in FIG. 1, the live streaming device 100 may collect the voice information of the anchor in real time by an audio acquisition device (for example, a built-in microphone or an external microphone, or the like). In some other possible embodiments, when the live streaming device 100 is, for example, the live streaming server 11 in FIG. 1, the live streaming device 100 may receive the voice information collected and sent by the first terminal device 12, for example, obtain the voice information from the video stream pushed by the first terminal device 12.

Step 203: extracting keywords and sound feature information from the voice information.

In some possible embodiments, after obtaining the voice information of the anchor, the live streaming device 100 may extract the keywords and the sound feature information from the voice information in parallel, or may extract the keywords and the sound feature information sequentially according to a specified sequence. It may be understood that the embodiment of the present application has no limitation on the extracting sequence of the keywords and the sound feature information.

In some possible scenarios, the above-mentioned sound feature information may be pitch information, amplitude information, frequency information, a low-frequency signal spectrum, or the like. The embodiment of the present application has no limitation on a specific algorithm for extracting the sound feature information, as long as the corresponding sound feature information may be extracted.

In addition, in some possible embodiments, the live streaming device 100 may extract the keywords from the voice information in various ways. For example, the keywords may be extracted from the voice information based on a preset keyword library. The keyword library may include: preset keywords configured to indicate an emotional state of the anchor, such as “happy”, “joyful”, “cheerful”, “sad”, “upset”, “worry”, “excited”, “ha-ha”, “cry”, or the like; and preset keywords configured to indicate an action to be performed by the anchor, such as “bye” (which may be configured to indicate an action, such as waving, or the like), “excitement” (which may be configured to indicate an action, such as dancing, or the like), “saluting”, “turning”, or the like. It may be understood that the keyword library may be stored in the live streaming device 100, or a third-party server.

In some possible embodiments, the live streaming device 100 may recognize the above-mentioned voice information, and detect whether the recognition result includes a keyword in the keyword library; when detecting that the recognition result includes the keyword in the keyword library, the live streaming device 100 may extract the keyword.

In addition, in some other possible embodiments, the live streaming device 100 may also perform word segmentation on a sentence corresponding to the voice information by a neural network model, to obtain a plurality of words. Each obtained word is recognized by the neural network model to obtain the type of each word, that is, whether each word indicates an emotional state or an action is recognized. When the word indicates an emotional state or an action, the live streaming device 100 may treat the word as the extracted keyword.

Step 205: determining a current emotional state of the anchor according to the extracted keywords and sound feature information.

In some possible scenarios, the live streaming device 100 or the third-party server in communication with the live streaming device 100 may store a plurality of corresponding relationships, which may be, for example, corresponding relationships between different keywords and different emotional states, or corresponding relationships between different sound feature information and different emotional states.

Thus, in some possible embodiments, the live streaming device 100 may determine the current emotional state of the anchor according to the corresponding relationship, as well as the extracted keywords and sound feature information.

It should be noted that, in some possible scenarios, for the extracted keyword and sound feature information of the same voice information, when the emotional state determined based on the keyword and the emotional state determined based on the sound feature information are two opposite emotional states (for example, “happiness” and “sadness”), the live streaming device 100 may determine physiological parameter information (for example, a degree of muscular tension, whether excited, or the like) at the time of sound production of the anchor based on the low-frequency signal spectrum of the voice information, and determine psychological state information of the anchor based on the physiological parameter information, such that one of the two emotional states may be selected as the current emotional state of the anchor based on the physiological parameter information.

Additionally, in some other embodiments, the live streaming device 100 may also implement step 205 using a neural network model. For example, a plurality of pieces of voice information of a plurality of anchors may be obtained; keywords and sound feature information are extracted from each piece of voice information to form a sample, and an actual emotional state when the anchor produces the voice is labeled into the sample, so as to form a sample set; and then, the pre-established neural network model is trained adopting the sample set to obtain a trained neural network model. Or, the neural network model may include a first neural network submodel and a second neural network submodel, the first neural network submodel may be configured to identify keywords, the second neural network submodel may be configured to identify a sound state, and the first neural network submodel and the second neural network submodel may perform identification in parallel.

As such, when executing step 205, the live streaming device 100 may input the extracted keywords and sound feature information into the trained neural network model, so as to obtain the current emotional state of the anchor.

It should be noted that the above-mentioned two implementations are merely examples, and in some other possible implementations of the embodiment of the present application, step 205 may also be implemented in other manners, and the embodiment of the present application has no limitation on the implementation of step 205.

Step 207: obtaining, by matching, from a pre-stored action instruction set, a corresponding target action instruction according to the current emotional state and the keywords.

In some possible scenarios, the pre-stored action instruction set may be stored in the live streaming device 100 or the third-party server communicatively connected to the live streaming device 100. Correspondingly, the live streaming device 100 or the third-party server communicatively connected to the live streaming device 100 may further store an association relationship between each action instruction in the pre-stored action instruction set and the emotional state and between each action instruction in the pre-stored action instruction set and the keyword.

In some possible scenarios, the action instructions may be divided into two categories: action instructions which may be applied to various virtual images, and may be referred to herein as “general action instructions”; and action instructions which may only be applied to some specific virtual images, by means of the action instructions, specific live streaming special effects may be achieved, and the action instructions may be referred to herein as “customized action instructions”.

Correspondingly, the pre-stored action instruction set may include a general instruction set storing the general action instructions and a customized instruction set storing the customized action instructions. In a possible embodiment, when the anchor uses a specific virtual image, the first terminal device 12 may download and save the customized instruction set corresponding to the specific virtual image. In another possible embodiment, charging service may be set for the customized instruction set, and when the anchor selects the specific virtual image and pays a corresponding fee, the first terminal device 12 may download and save the customized instruction set corresponding to the specific virtual image.

Optionally, as a possible implementation, step 207 may be implemented by following processes:

in a case where a first action instruction associated with the current emotional state and the keywords exists in the pre-stored action instruction set, taking the first action instruction as the target action instruction;

in a case where the first action instruction does not exist in the pre-stored action instruction set, obtaining, from the pre-stored action instruction set, a second action instruction corresponding to the current emotional state and a third action instruction associated with the keywords; and determining the target action instruction according to the second action instruction and the third action instruction.

In the above, the first action instruction may be associated with the current emotional state and may also be associated with the keyword, and the first action instruction and a spoken content of the anchor have a higher matching degree, such that the first action instruction may be directly used as the target action instruction in the case where the first action instruction exists.

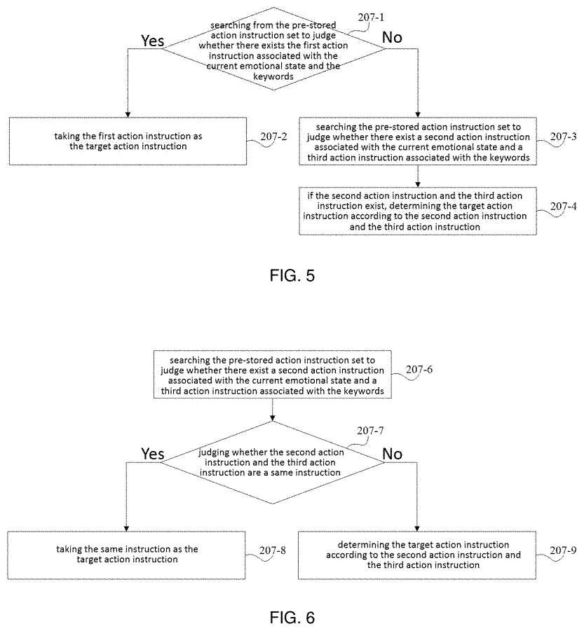

Exemplarily, the live streaming device 100 may implement the above-mentioned process of step 207 through different execution logics. For example, as a possible implementation, the process of step 207 may be implemented through the steps shown in FIG. 5.

Step 207-1: searching from the pre-stored action instruction set to judge whether there exists the first action instruction associated with the current emotional state and the keyword, wherein if yes, step 207-2 is executed; if no, step 207-3 is executed.

In a possible implementation, the live streaming device 100 may use the current emotional state and the keyword as a search index to search for a corresponding action instruction, and the searched action instruction is the first action instruction.

Step 207-2: taking the first action instruction as the target action instruction.

Step 207-3: searching from the pre-stored action instruction set to respectively judge whether there exists the second action instruction associated with the current emotional state and the third action instruction associated with the keyword.

In a possible implementation, the live streaming device 100 may search for an action instruction from the pre-stored action instruction set with the current emotional state as a search index, and the searched action instruction is the second action instruction. The live streaming device 100 may search for an action instruction from the pre-stored action instruction set with the keyword as a search index, and the searched action instruction is the third action instruction.

Step 207-4: if the second action instruction and the third action instruction exist, determining the target action instruction according to the second action instruction and the third action instruction.

As another example, in another possible embodiment, the above-mentioned process of step 207 may also be implemented through the steps shown in FIG. 6.

Step 207-6: searching from the pre-stored action instruction set to judge whether there exists the second action instruction associated with the current emotional state and the third action instruction associated with the keyword.

Step 207-7: judging whether the second action instruction and the third action instruction are the same instruction, wherein if yes, step 207-8 is executed; if no, step 207-9 is executed.

Step 207-8: taking the same instruction as the target action instruction.

In the above, when the second action instruction and the third action instruction are the same instruction, the same instruction may serve as the first action instruction in the embodiment of the present application.

Step 207-9: determining the target action instruction according to the second action instruction and the third action instruction.

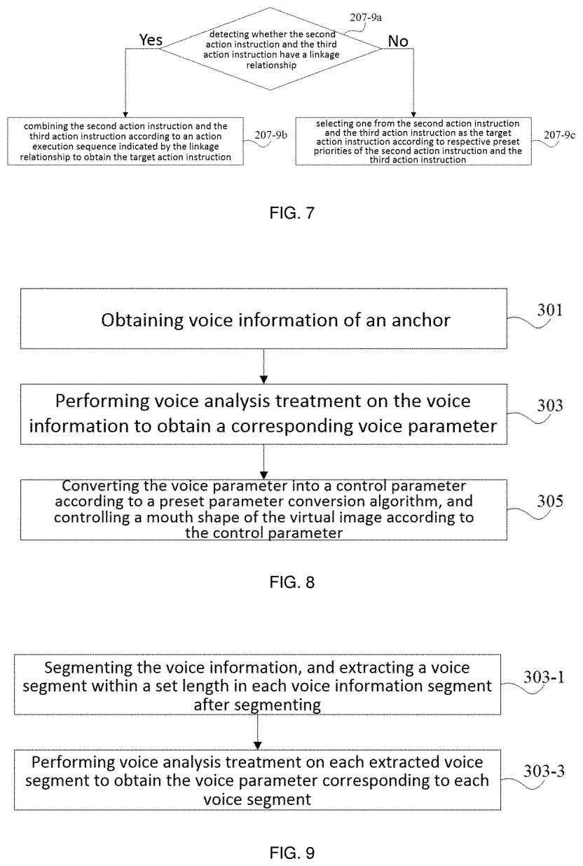

In some possible implementations, execution by the live streaming device 100 of the step of determining the target action instruction according to the second action instruction and the third action instruction (for example, above-mentioned step 207-4 or step 207-9) may be implemented through, for example, the steps shown in FIG. 7.

Step 207-9a: detecting whether the second action instruction and the third action instruction have a linkage relationship, wherein if yes, step 207-9b is executed; if no, step 207-9c is executed.

In some possible embodiments, the live streaming device 100 may store association relationships between the action instructions of the pre-stored action instruction set. The association relationship may be recorded in various ways, and the embodiment of the present application has no limitation on the recording way of the association relationship. For example, the association relationship may be saved in the form of one data record, each data record including identification information of a corresponding action instruction and a flag bit configured to indicate the type of the association relationship.

For example, data record a may be configured to represent the association relationship of action instructions 1 and 2, and then, the data record a may include the identification information (for example, preset number information) of each of the action instructions 1 and 2. The association relationship may be, for example, a linkage relationship or an approximate relationship; for example, the flag bit of 1 may indicate that there exists a linkage relationship between the action instructions recorded in the data record; the flag bit of 0 may indicate that there exists an approximate relationship between the action instructions recorded in the data record. It should be understood that the above-mentioned representation of the linkage relationship and the approximate relationship by using 0 and 1 is only illustrative, and in some other possible embodiments, the linkage relationship and the approximate relationship may also be represented by other values or characters, and the embodiment of the present application has no limitation on the identification manner of each of the linkage relationship and the approximate relationship.

In some possible embodiments, at least two action instructions having a linkage relationship may be combined into one action instruction in a certain sequence; for example, when an action instruction for implementing “laughing” and an action instruction for implementing “dancing” have a linkage relationship, the two action instructions may be combined into one action instruction, and the virtual image of the anchor may be controlled to perform “laughing” and “dancing” at one time by the combined action instruction.

Optionally, in some possible embodiments, for at least two action instructions having a linkage relationship, an execution sequence of each of the at least two action instructions may be set in a corresponding data record.

At least two action instructions having an approximate relationship refer to instructions configured to implement similar actions; for example, the action instruction configured to implement “laughing” and an action instruction configured to implement “smiling” may be considered as approximate action instructions, and the approximate relationship of the two action instructions “laughing” and “smiling” may be established.

Based on the above configuration, the live streaming device 100 may search for a first data record recording the identification information of the second action instruction and the identification information of the third action instruction at the same time. If the first data record is found, the type of the association relationship of the second action instruction and the third action instruction is determined according to a value of a flag bit in the first data record, and if the type of the association relationship indicated by the value of the flag bit is a linkage relationship, the second action instruction and the third action instruction may be determined to have a linkage relationship. If the association relationship indicated by the value of the flag bit is not a linkage relationship, or no first data record is found, the second action instruction and the third action instruction may be determined to have no linkage relationship.

Step 207-9b: combining the second action instruction and the third action instruction according to an action execution sequence indicated by the linkage relationship to obtain the target action instruction.

In some possible embodiments, the execution sequence set in the first data record may serve as the action execution sequence indicated by the linkage relationship.

Step 207-9c: selecting one from the second action instruction and the third action instruction as the target action instruction according to respective preset priorities of the second action instruction and the third action instruction.

In some possible embodiments, a priority may be set for each action instruction in the pre-stored action instruction set. As such, the live streaming device 100 may select one of the second action instruction and the third action instruction with a higher priority or a lower priority as the target action instruction according to actual needs. If the second action instruction and the third action instruction have same priorities, the live streaming device 100 may randomly select one as the target action instruction.

Optionally, in some possible embodiments, in order to increase a matching speed of the action instruction, the live streaming control method may further include the following steps.

First, for each keyword extracted from the voice information, a number of pieces of target voice information containing the keyword, as well as a first number of target action instructions determined according to a first number of pieces of newly obtained target voice information are counted.

Second, if the number of the pieces of target voice information reaches a second number and the first number of target action instructions are the same instruction, a corresponding relationship between the keyword and the same instruction is cached in a memory of the live streaming device.

In the above, the first number does not exceed the second number.

The above-mentioned two steps are explained below by way of an example. Assuming that:

the first number is 2 and the second number is 3;

voice information 1 is obtained for the first time, keywords aa, bb and cc are extracted from the voice information, and target action instruction t2 is determined based on the voice information 1 according to the steps shown in FIG. 4;

voice information 2 is obtained for the second time, keywords aa and dd are extracted from the voice information, and target action instruction t1 is determined based on the voice information 2 according to the steps shown in FIG. 4;

voice information 3 is obtained for the third time, keyword bb is extracted from the voice information, and target action instruction t3 is determined based on the voice information 3 according to the steps shown in FIG. 4;

voice information 4 is obtained for the fourth time, keywords aa and bb are extracted from the voice information, and target action instruction t1 is determined based on the voice information 4 according to the steps shown in FIG. 4;

voice information 5 is obtained for the fifth time, keyword cc is extracted from the voice information, and target action instruction t2 is determined based on the voice information 5 according to the steps shown in FIG. 4.

In the above example, for the keyword aa, the corresponding target voice information is voice information 1, voice information 2, and voice information 4; that is, the number of pieces of target voice information including the keyword aa is 3, and reaches the second number 3, wherein two of the target action instructions determined based on the voice information 1, the voice information 2 and the voice information 4 are same and are both t1; that is, the first number 2 is reached. Therefore, the corresponding relationship between the keyword aa and the action instruction t1 may be established, and cached in the memory of the live streaming device 100. When the voice information containing the keyword aa is obtained again, the action instruction t1 may be directly determined as the target action instruction.

Based on the above description, after executing step 207-3, the cached corresponding relationships may be first searched to judge whether there exists a corresponding relationship hit by the keyword; if yes, the instruction recorded in the hit corresponding relationship is determined as the target action instruction; if no, step 207-4 is re-executed.

Considering that the anchor may use the same keyword to express changed meanings in different time periods, the live streaming device 100 may empty the corresponding relationships cached in the memory at intervals of a first preset duration.

As such, the corresponding relationships cached in the live streaming device 100 may be guaranteed to be adapted to a latest wording habit of the anchor.

Referring again to FIG. 4, after determining the target action instruction, the live streaming device 100 may perform step 209.

Step 209: executing the target action instruction, and controlling a virtual image in a live streaming picture to execute an action corresponding to the target action instruction.

In some possible embodiments, the live streaming device 100 may process the virtual image according to the target action instruction, so as to generate a corresponding live streaming video stream, and directly or indirectly send the live streaming video stream to the second terminal device 13.

Optionally, in some possible embodiments, to increase an interestingness and avoid the virtual image of the anchor from performing repeated actions in a short time, the following steps may be performed before executing step 209.

First, a current time is obtained, and whether an interval between the current time and a latest execution time of the target action instruction exceeds a second preset duration is judged; if the second preset duration is exceeded, step 209 is executed.

For each action instruction in the pre-stored action instruction set, the live streaming device 100 may record the latest execution time of the action instruction. It should be noted that, for the action instruction which is not executed, the latest execution time recorded by the live streaming device 100 may be null or a preset default value.

Then, if the second preset duration is not exceeded, the live streaming device 100 searches from the pre-stored action instruction set for another action instruction having an approximate relationship with the target action instruction to replace the target action instruction, and executes the replaced target action instruction.

In the above, the live streaming device 100 may search from the stored data records for a second data record containing identification information of the target action instruction, then obtain other identification information different from identification of the target action instruction from the searched second data record, and replace the target action instruction with the action instruction indicated by the other identification information.

In addition, for some specific scenarios, some specific parts of the virtual image may be controlled, such that some specific parts of the virtual image may perform some actions corresponding to the voice information, so as to improve precision of control over the virtual image.

For example, referring to FIG. 8, FIG. 8 is a schematic flow chart of another live streaming control method according to an embodiment of the present application, and the virtual image displayed in the live streaming picture may be controlled using the live streaming control method. Method steps defined by the flow related to the live streaming control method may be implemented by the above-mentioned live streaming device 100. A specific flow shown in FIG. 8 will be exemplarily explained below.

Step 301: obtaining voice information of an anchor.

In some possible embodiments, the live streaming device 100 may obtain the voice information of the anchor in real time by a voice acquisition device (such as a microphone of a mobile phone, a connected microphone, or the like). For example, in a possible example, if the live streaming device 100 is a terminal device used by the anchor, the voice information of the anchor may be directly obtained by the voice acquisition device, such as the connected microphone, the built-in microphone, or the like. For another example, in another possible example, if the live streaming device 100 is a backend server, after obtaining the voice information of the anchor, the terminal device used by the anchor may send the voice information to the backend server.

Step 303: performing voice analysis treatment on the voice information to obtain a corresponding voice parameter.

In some possible embodiments, after obtaining the voice information through step 301, the live streaming device 100 may analyze and process the voice information to obtain the corresponding voice parameter.

In some possible embodiments, in order to ensure that the voice parameter obtained by analysis has higher accuracy, before executing step 303, the voice information may be further preprocessed, and the preprocessing manner may be described as follows, for example.

First, the live streaming device 100 may convert the obtained voice information into narrow-band voice information in a resampling manner; then, the obtained voice information is filtered by a band-pass filter to obtain voice information with a frequency belonging to a passband of the band-pass filter, wherein the passband of the band-pass filter is generally determined based on a fundamental frequency and a formant of human sounds; and finally, noise of obtained audio data of a user is filtered out using an audio noise reduction algorithm.

It should be noted that, considering that the fundamental frequency of the human sounds generally belongs to (90, 600) Hz, a high-pass filter with a cut-off frequency of 60 Hz may be provided; then, from the fundamental frequency and the formants (the formants may include a first formant, a second formant, and a third formant), it may be known that a main frequency of the human sounds is generally below 3 kHz; therefore, a low-pass filter with a cut-off frequency of 3 kHz may be provided. That is to say, the foregoing band-pass filter may be composed of a high-pass filter with a cut-off frequency of 60 Hz and a low-pass filter with a cut-off frequency of 3 kHz, such that voice information with a frequency not belonging to (60, 3000) Hz may be effectively filtered out, thus effectively avoiding a problem of interference of environmental noise in voice analysis treatment.

Step 305: converting the voice parameter into a control parameter according to a preset parameter conversion algorithm, and controlling a mouth shape of the virtual image according to the control parameter.

In some possible embodiments, after obtaining the voice parameter through step 303, the live streaming device 100 may convert the voice information into the corresponding control parameter based on the preset parameter conversion algorithm, and then control the mouth shape of the virtual image based on the control parameter.

Using the above-mentioned method, the live streaming device 100 may control the mouth shape of the virtual image based on the voice information of the anchor, such that the voice information broadcast in live streaming has a higher consistency with the mouth shape of the virtual image, thereby increasing the precision of the control over the virtual image and effectively improving user experience. Moreover, since the mouth shape of the virtual image is determined based on the voice information; that is, different voice information corresponds to different mouth shapes, a live streaming flexibility of the virtual image may be improved based on a change of the mouth shape, so as to improve the live streaming interestingness.

It should be noted that the specific manner in which the live streaming device 100 executes step 303 to analyze and process the voice information is not limited, and may be selected according to actual application demands. For example, with reference to FIG. 9, as a possible embodiment, step 303 may include step 303-1 and step 303-3, and content of steps included in step 303 may be described as follows.

Step 303-1: segmenting the voice information, and extracting a voice segment within a set length in each voice information segment after segmenting.

In a possible embodiment, the live streaming device 100 may segment the voice information based on a preset rule to obtain at least one voice information segment. Then, the voice segment within the set length in each voice information segment is extracted to obtain at least one voice segment.

In the above, the set length may be a duration, for example, 1 s, 2 s, 3 s, or the like; or may be a length in other dimensions, for example, a length based on a corresponding number of words (for example, 2 words, 3 words, 4 words, or the like).

Step 303-3: performing voice analysis treatment on each extracted voice segment to obtain the voice parameter corresponding to each voice segment.

In a possible embodiment, after obtaining the at least one voice segment through step 303-1, the live streaming device 100 may perform the voice analysis treatment on each voice segment, so as to obtain the voice parameter corresponding to each voice segment. Correspondingly, after each voice segment is analyzed and processed by the live streaming device 100, at least one voice parameter may be obtained.

The specific manner in which the live streaming device 100 executes step 303-1 to segment the voice information is not limited, and may be selected according to actual application demands. For example, as a possible implementation, step 303-1 may be: extracting the voice segment within the set length in the voice information at intervals of the set length. For example, the obtained voice information may have a length of 1 s, the set length may be 0.2 s, and correspondingly, 5 voice segments with a length of 0.2 s may be obtained through the segmentation processing. For another example, the obtained voice information may have a length of 20 words, the set length may be 5 words, and correspondingly, 4 voice segments with a length of 5 words may be obtained through the segmentation processing.

Also, as another possible implementation, the live streaming device 100 may perform the segmentation processing based on a continuity of the voice information. For example, step 303-1 may be: segmenting the voice information according to the continuity of the voice information, and extracting the voice segment within the set length in each voice information segment after the segmentation.

That is to say, after obtaining the voice information, the live streaming device 100 may identify the voice information to judge whether a pause exists in the voice information segment (the pause may be judged by analyzing a waveform of the voice information, and if the waveform has an interruption and a duration of the interruption is longer than a preset duration, the pause may be determined to exist). For example, if the voice information is “today live streaming is over, and tomorrow we will . . . ”, then, by identifying the voice information, a pause may be determined to occur at “,”, and therefore, a voice information segment may be obtained, which is “today live streaming is over”. Then, a voice segment with a set length may be extracted in the voice information segment. A specific size of the set length is not limited and may be selected according to actual application requirements.

For example, as a possible implementation, the set length may be less than a length of the corresponding voice information segment (for example, a voice information segment has a length of 0.8 s, and the set length may be 0.6 s, or a voice information segment has a length of 8 words, and the set length may be 6 words), such that a data amount of the obtained voice segment is less than a data amount of the voice information of the anchor, thereby reducing a processing amount or an operation amount of data when steps 303-3 and 305 are executed, and further effectively ensuring that the live streaming of the virtual image has a higher real-time performance. Moreover, since the processing amount of data is reduced, a requirement for a processing performance of the live streaming device 100 may be reduced, thereby improving an adaptability of the virtual image control method.

It should be noted that when the live streaming device 100 segments a voice based on the continuity, different set lengths may be configured for each voice information segment. For example, as a possible implementation, a corresponding set length may be configured based on the length of each voice information segment. For example, if a voice information segment has a length of 0.6 s (or 6 words), the configured set duration may be 0.3 s (or 3 words); if a voice information segment has a length of 0.4 s (or 4 words), the configured set duration may be 0.2 s (or 2 words). For another example, if a voice information segment has a length of 0.6 s (or 6 words), the configured set duration may be 0.5 s (or 5 words); if a voice information segment has a length of 0.4 s (or 4 words), the configured set duration may be 0.3 s (or 3 words).

Moreover, after the length configuration of the set length, a start position (such as a start time or a start word) or an end position (such as an end time or an end word) of the set length may not be limited, and may be configured according to actual application requirements. For example, as a possible implementation, a voice segment with any time as the start time or the end time may be extracted in a voice information segment.

For another example, in another possible implementation, a voice segment with an end time of a voice information segment as the end time may be extracted in the voice information segment. For example, a voice information segment has a start time of “15 h: 40 min: 10.23 s”, an end time of “15 h: 40 min: 10.99 s”, and a set duration of 0.50 s, and the extracted voice segment has an end time of “15 h: 40 min: 10.99 s” and a start time of “15 h: 40 min: 10.49 s”.

As such, the aforesaid setting may ensure that a content of each voice information segment close to the end time and a corresponding mouth shape have a uniformity, such that while the operation amount of data is reduced, an audience may be difficult to find out a situation where the voice information does not correspond to the mouth shape, the mouth shape of the anchor is shown more vividly, so as to effectively ensure that the audience has a higher experience degree. For example, in the above-mentioned example “today live streaming is over, and tomorrow we will . . . ”, if the voice and the mouth shape corresponding to “is over” may be guaranteed to be consistent, the audience may be difficult to find out or even ignore a problem that the voice and the mouth shape corresponding to “today live streaming” are inconsistent, and then, the audience will think that the voice broadcast in live streaming has a higher consistency with the mouth shape of the virtual image.

It should be noted that, when the live streaming device 100 segments the voice information based on the continuity, after the pause is detected, if the voice information of the anchor is detected again, as in the above-mentioned example “today live streaming is over, and tomorrow we will . . . ”, after the pause, the voice information “tomorrow we will . . . ” is detected again, and at this point, in order to make the mouth shape of the virtual image more consistent with the broadcast voice, a voice segment with a preset length may also be extracted from the voice information. For example, a voice segment of a preset length (for example, 0.4 s) may be extracted with the start time of the voice information as the start time, or a voice segment of a preset length (for example, 2 words) may be extracted with a first word of the voice information as the start word.

That is to say, for each obtained voice information segment, two voice segments of the head and tail in the voice information segment may be obtained, respectively, and the mouth shape of the virtual image may be controlled based on the two voice segments. For example, in the above-mentioned example “today live streaming is over”, two voice segments “today” and “is over” may be extracted, such that the contents and the mouth shapes corresponding to the two voice segments have a consistency, such that the audience thinks that the content and the mouth shape corresponding to “today live streaming is over” have a consistency.

It should be noted that, in the above-mentioned example, if two voice segments are extracted for a voice information segment, respectively, the two voice segments may have same or different lengths. When the two voice segments have different lengths, the length of the tail voice segment may be greater than the length of the head voice segment.

In addition, the specific manner in which the live streaming device 100 executes step 303-3 to perform the voice analysis treatment is not limited, and may be selected according to actual application demands. For example, as a possible implementation, the live streaming device 100 may perform analysis and processing based on amplitude information and/or frequency information in the voice information.

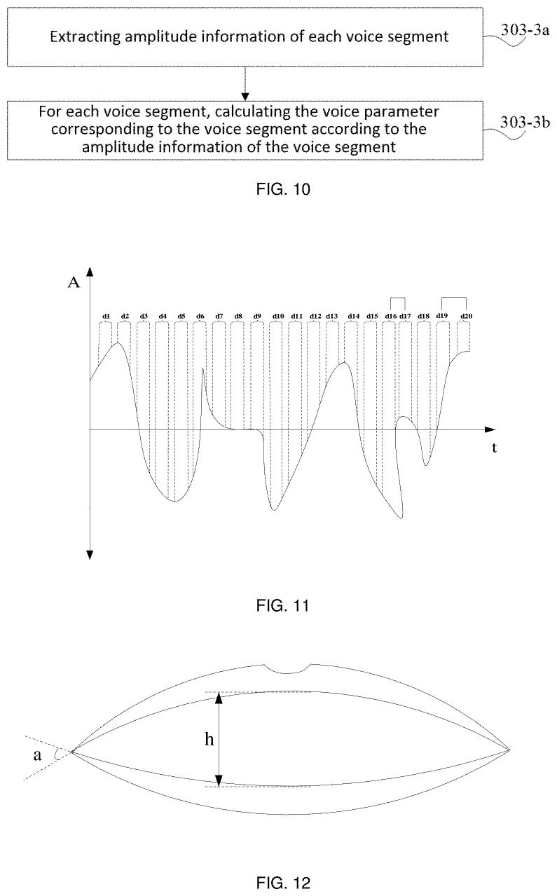

For example, the live streaming device 100 may perform the voice analysis treatment based on the amplitude information when performing step 303-3. Exemplarily, with reference to FIG. 10, as a possible implementation, step 303-3 may include step 303-3a and step 303-3b, which may be specifically described as follows.

Step 303-3a: extracting amplitude information of each voice segment.

In a possible embodiment, after obtaining at least one voice segment through step 303-1, the live streaming device 100 may first extract the amplitude information of each voice segment.

Step 303-3b: for each voice segment, calculating the voice parameter corresponding to voice segment according to the amplitude information of the voice segment.

In a possible embodiment, after obtaining the amplitude information of each voice segment through step 303-3a, the live streaming device 100 may calculate the voice parameter corresponding to each voice segment based on the amplitude information, wherein, the voice parameter may be any value in the interval (0, 1); that is, the live streaming device 100 may process the obtained amplitude information based on a normalization algorithm to obtain the corresponding voice parameter.

Exemplarily, the live streaming device 100 may perform a calculation according to frame length information and the amplitude information of the voice segment using the normalization algorithm to obtain the voice parameter corresponding to the voice segment.

It should be noted that, based on different ways of extracting the voice segment, the obtained voice segments generally have different lengths, and the voice parameter of each voice segment may also be generally calculated in different ways. For example, if one voice segment is long, one voice parameter may be calculated for each frame of voice data in the voice segment; if one voice segment is short, the voice segment may be used as one frame of voice data, such that one voice parameter may be calculated based on the frame of voice data and used as the voice parameter corresponding to the voice segment.

That is to say, for each frame of voice data, the live streaming device 100 may calculate a numerical value belonging to the interval (0, 1) according to the normalization algorithm based on the frame length information and the amplitude information of the frame of voice data, and the numerical value may be used as the voice parameter corresponding to the frame of voice data. For example, in the above-mentioned example “today live streaming is over, and tomorrow we will . . . ”, the live streaming device 100 may extract 20 frames of voice data, and then perform normalization calculation on an amplitude of each frame of voice data to obtain 20 numerical values as 20 voice parameters corresponding to the 20 frames of voice data (as shown in FIG. 11).

It should be noted that a specific content of the normalization algorithm is not limited, and may be selected according to actual application requirements. For example, the live streaming device 100 may first calculate a sum of squares of the amplitude information at each moment in one frame of voice data, then calculate a mean value of the sum of squares of the amplitude information of the frame of voice data based on a frame length of the frame of voice data, and perform a square root operation on the mean value of the sum of squares to obtain the corresponding voice parameter.

Optionally, the specific manner in which the live streaming device 100 executes step 305 to convert the voice parameter into the control parameter is also not limited, and may be selected according to actual application requirements. That is to say, in some possible implementations, a specific content of the parameter conversion algorithm is not limited. For example, the specific content of the parameter conversion algorithm may be different according to different specific contents of the control parameter.

Exemplarily, as a possible implementation, the control parameter may include, but is not limited to, at least one of lip spacing between upper and lower lips and a mouth corner angle of the virtual image.

For example, when the control parameter includes the lip spacing, the lip spacing may be calculated according to the voice parameter and preset maximum lip spacing corresponding to the virtual image using the preset parameter conversion algorithm. When the control parameter includes the mouth corner angle, the mouth corner angle may be calculated according to the voice parameter and a preset maximum mouth corner angle corresponding to the virtual image using the preset parameter conversion algorithm.

For example, if the maximum lip spacing is 5 cm and the normalized voice parameter is 0.5, the control parameter may include 0.5×5=2.5 cm; that is to say, at this time, the lip spacing between the upper and lower lips of the virtual image may be controlled to 2.5 cm (h as shown in figure). Similarly, if the maximum mouth corner angle is 120° and the normalized voice parameter is 0.5, the control parameter may include 0.5×120=60°; that is to say, at this time, the mouth corner angle of the virtual image may be controlled to 60° (a as shown in FIG. 12).

Optionally, when the control parameter includes the lip spacing, a specific value of the maximum lip spacing may not be limited, and may be set according to an actual application requirement. For example, as a possible implementation, the maximum lip spacing may be set based on lip spacing of the anchor.

For example, for anchor A, after a test, the maximum lip spacing of the virtual image corresponding to the anchor may be set to 5 cm if the maximum lip spacing of the anchor is 5 cm; for anchor B, after a test, the maximum lip spacing of the virtual image corresponding to the anchor may be set to 6 cm if the maximum lip spacing of the anchor is 6 cm.

Similarly, when the control parameter includes the mouth corner angle, a specific value of the maximum mouth corner angle may not be limited, and may be set according to an actual application requirement. For example, as a possible implementation, the maximum mouth corner angle may be set based on a mouth corner angle of the anchor.

For example, for anchor A, after a test, the maximum mouth corner angle of the virtual image corresponding to the anchor may be set to 120° if the maximum mouth corner angle of the anchor is 120°; for anchor B, after a test, the maximum mouth corner angle of the virtual image corresponding to the anchor may be set to 135° if the maximum mouth corner angle of the anchor is 135°.

Therefore, with the above-mentioned setting, the mouth shape of the virtual image may have a higher consistency with an actual mouth shape of the corresponding anchor, thereby achieving more vivid image display in live streaming. Moreover, since different anchors generally have different maximum lip spacing and maximum mouth corner angles, the virtual images corresponding to the different anchors have different maximum lip spacing and maximum mouth corner angles, such that when watching the live streaming of the virtual images corresponding to the different anchors, the audience may view different mouth shapes (different maximum lip spacing and/or maximum mouth corner angles), and the virtual images have a higher flexibility, thereby improving the interestingness of the live streaming.

In addition, the embodiment of the present application further provides a live streaming control method, which may include, for example, all steps of the methods described in FIGS. 4 and 8, such that when the virtual image is controlled using the live streaming control method, not only the virtual image in the live streaming picture may be controlled to execute the action corresponding to the target action instruction, but also the mouth shape of the virtual image may be controlled, thereby improving the precision of control over the virtual image.

It should be noted that, for convenience and simplicity of description, reference is made to the above-mentioned embodiments, for example, for FIGS. 4 and 8, specifically for the implementation of each specific flow and step of the live streaming control method, which is not repeated in the embodiment of the present application.

In some schematic embodiments of the present application, it should be understood that the disclosed method, flow, or the like, may also be implemented in other manners. The method embodiments described above are merely schematic, for example, the flow diagram and the block diagram in the drawings show the system architectures, functions and operations that may be implemented by the method and computer program product according to the embodiments of the present application. In this regard, each block in the flow diagrams or block diagrams may represent a module, program segment, or portion of code, which includes one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flow diagrams, and combinations of blocks in the block diagrams and/or flow diagrams, can be implemented by special-purpose hardware-based systems that perform the specified functions or actions, or combinations of special-purpose hardware and computer instructions.

In addition, the respective functional modules in the embodiments of the present application can be integrated together to form an independent part, or can exist independently in a form of single module, or can be integrated, in a form of two or more modules, to form an independent part.

When implemented in a form of software functional module and sold or used as independent products, these functions can be stored in a computer readable storage medium. Based on such understanding, the technical solution provided the embodiment of the present application essentially, in other words, the part that makes contributions to the prior art, or a part of the technical solution may be embodied in the form of a software product, and the computer software product is stored in a storage medium, including several instructions for enabling one computer device (which may be a personal computer, an electronic device, a network device, or the like) to execute all or some of the steps of the methods according to the embodiments of the present application. Moreover, the above-mentioned storage medium includes various media capable of storing program codes, such as a USB flash disk, a mobile hard disk, a read-only memory (ROM), a random access memory (RAM), a magnetic disk, an optical disk, or the like. It should be noted that, in the whole text, the term “comprising”, “including”, or any other variant thereof is intended to encompass a non-exclusive inclusion, so that the process, method, article or device including a series of elements does not only include those elements, but also includes other elements not explicitly listed, or further includes inherent elements of the process, method, article or device. In cases where no further limitations are made, the element defined with the statement “including one . . . ” does not exclude the case that other identical elements further exist in the process, method, article or device including the element.

Finally, it should be noted that the above descriptions are only part of the embodiments of the present application and are not intended to limit the present application; although the present application has been described in detail with reference to the foregoing embodiments, it will be apparent to those skilled in the art that modifications may be made to the technical solution of the embodiments described above, or equivalents may be substituted for part of technical features thereof. Any modification, equivalent replacement, or improvement made within the spirit and principle of the present application shall be included in the protection scope of the present application.

### INDUSTRIAL APPLICABILITY

By obtaining the voice information of the anchor, the virtual image in the live streaming picture is controlled to execute the action matched with the voice information, so as to improve the precision of the control over the virtual image.

1. A live streaming control method, applicable to a live streaming device, wherein the method comprises following steps:
obtaining voice information of an anchor;
extracting keywords and sound feature information from the voice information;
determining a current emotional state of the anchor according to the extracted keywords and the extracted sound feature information;
obtaining, by matching, from a pre-stored action instruction set, a corresponding target action instruction according to the current emotional state and the keywords; and
executing the target action instruction, and controlling a virtual image in a live streaming picture to execute an action corresponding to the target action instruction.

2. The live streaming control method according to claim 1, wherein the pre-stored action instruction set comprises a general instruction set and a customized instruction set corresponding to a current virtual image of the anchor, wherein the general instruction set stores general action instructions configured to control each virtual image, and the customized instruction set stores customized action instructions configured to control the current virtual image.

3. The live streaming control method according to claim 1, wherein the step of matching, from a pre-stored action instruction set, an action instruction according to the current emotional state and the keywords comprises following steps:
taking a first action instruction as the target action instruction in a case where the first action instruction associated with the current emotional state and the keywords exists in the pre-stored action instruction set;
obtaining, from the pre-stored action instruction set, a second action instruction corresponding to the current emotional state and a third action instruction associated with the keywords in a case where the first action instruction does not exist in the pre-stored action instruction set; and
determining the target action instruction according to the second action instruction and the third action instruction.

4. The live streaming control method according to claim 3, wherein the step of determining the target action instruction according to the second action instruction and the third action instruction comprises a following step:
detecting whether the second action instruction and the third action instruction have a linkage relationship, wherein
if the linkage relationship exists, the second action instruction and the third action instruction is combined according to an action execution sequence indicated by the linkage relationship, to obtain the target action instruction; and
if the linkage relationship does not exist, one of the second action instruction and the third action instruction is selected as the target action instruction according to respective preset priorities of the second action instruction and the third action instruction.

5. The live streaming control method according to claim 1, wherein the method further comprises following steps:
counting, for each of the keywords extracted from the voice information, a number of pieces of target voice information containing a keyword, as well as a first number of target action instructions determined according to a first number of pieces of newly obtained target voice information; and
caching a corresponding relationship between the keyword and a same instruction in a memory of the live streaming device if the number of pieces of target voice information reaches a second number and the first number of target action instructions are the same instruction, wherein the first number does not exceed the second number; and
wherein the step of matching, from a pre-stored action instruction set, an action instruction according to the current emotional state and the keywords comprises a following step:
searching from cached corresponding relationships to judge whether a corresponding relationship hit by the keyword exists, wherein
if yes, an instruction recorded in a hit corresponding relationship is determined as the target action instruction; and
if no, the step of matching, from a pre-stored action instruction set, an action instruction according to the current emotional state and the keywords is executed again.

6. The live streaming control method according to claim 5, wherein the method further comprises a following step:
emptying the cached corresponding relationships in the memory every first preset duration.

7. The live streaming control method according to claim 1, wherein for each action instruction in the pre-stored action instruction set, the live streaming device records a latest execution time of the action instruction; and
the step of executing the target action instruction comprises a following step:
obtaining a current time, and judging whether an interval between the current time and the latest execution time of the target action instruction exceeds a second preset duration, wherein
if the second preset duration is exceeded, the target action instruction is executed again; and
if the second preset duration is not exceeded, the pre-stored action instruction set is searched for other action instructions having an approximate relationship with the target action instruction, to replace the target action instruction, and a replaced target action instruction is executed.

8. A live streaming control method, applicable to a live streaming device, wherein the live streaming device is configured to control a virtual image displayed in a live streaming picture, the method comprises following steps:
obtaining voice information of an anchor;
performing voice analysis treatment on the voice information to obtain a corresponding voice parameter; and
converting the voice parameter into a control parameter according to a preset parameter conversion algorithm, and controlling a mouth shape of the virtual image according to the control parameter.

9. The live streaming control method according to claim 8, wherein the step of performing voice analysis treatment on the voice information to obtain a corresponding voice parameter comprises following steps:
segmenting the voice information, and extracting a voice segment within a set duration in each voice information segment after segmenting; and
performing voice analysis treatment on each extracted voice segment to obtain a voice parameter corresponding to each voice segment.

10. The live streaming control method according to claim 9, wherein the step of segmenting the voice information, and extracting a voice segment within a set duration in each voice information segment after segmenting comprises a following step:
extracting the voice segment within the set duration in the voice information at intervals of the set duration.

11. The live streaming control method according to claim 9, wherein the step of segmenting the voice information, and extracting a voice segment within a set duration in each voice information segment after segmenting comprises a following step:
segmenting the voice information according to continuity of the voice information, and extracting the voice segment within the set duration in each voice information segment after segmenting.

12. The live streaming control method according to claim 9, wherein the step of performing voice analysis treatment on each extracted voice segment to obtain a voice parameter corresponding to each voice segment comprises following steps:
extracting amplitude information of each voice segment; and
calculating the voice parameter corresponding to each voice segment according to the amplitude information of each voice segment.

13. The live streaming control method according to claim 12, wherein the step of calculating the voice parameter corresponding to each voice segment according to the amplitude information of each voice segment comprises a following step:
performing a calculation according to frame length information and the amplitude information of the voice segment using a normalization algorithm, to obtain the voice parameter corresponding to the voice segment.

14. The live streaming control method according to claim 8, wherein the control parameter comprises at least one of a lip spacing between upper and lower lips and a mouth corner angle of the virtual image.

15. The live streaming control method according to claim 14, wherein when the control parameter comprises the lip spacing, the lip spacing is calculated according to the voice parameter and a preset maximum lip spacing corresponding to the virtual image using the preset parameter conversion algorithm; and
when the control parameter comprises the mouth corner angle, the mouth corner angle is calculated according to the voice parameter and a preset maximum mouth corner angle corresponding to the virtual image using the preset parameter conversion algorithm.

16. The live streaming control method according to claim 14, wherein when the control parameter comprises the lip spacing, a maximum lip spacing is set according to a pre-obtained lip spacing of the anchor; and
when the control parameter comprises the mouth corner angle, a maximum mouth corner angle is set according to a pre-obtained mouth corner angle of the anchor.

17. A live streaming control method, applicable to a live streaming device, the method comprising:
obtaining voice information of an anchor;
extracting keywords and sound feature information from the voice information;
determining a current emotional state of the anchor according to the extracted keywords and the extracted sound feature information;
obtaining, by matching, from a pre-stored action instruction set, a corresponding target action instruction according to the current emotional state and the keywords;
executing the target action instruction, and controlling a virtual image in a live streaming picture to execute an action corresponding to the target action instruction;
performing voice analysis treatment on the voice information to obtain a corresponding voice parameter; and
converting the voice parameter into a control parameter according to a preset parameter conversion algorithm, and controlling a mouth shape of the virtual image according to the control parameter.

18. (canceled)

19. (canceled)

20. The live streaming control method according to claim 2, wherein the step of matching, from a pre-stored action instruction set, an action instruction according to the current emotional state and the keywords comprises following steps:
taking a first action instruction as the target action instruction in a case where the first action instruction associated with the current emotional state and the keywords exists in the pre-stored action instruction set;
obtaining, from the pre-stored action instruction set, a second action instruction corresponding to the current emotional state and a third action instruction associated with the keywords in a case where the first action instruction does not exist in the pre-stored action instruction set; and
determining the target action instruction according to the second action instruction and the third action instruction.

21. The live streaming control method according to claim 2, wherein the method further comprises following steps:
counting, for each of the keywords extracted from the voice information, a number of pieces of target voice information containing a keyword, as well as a first number of target action instructions determined according to a first number of pieces of newly obtained target voice information; and
caching a corresponding relationship between the keyword and a same instruction in a memory of the live streaming device if the number of pieces of target voice information reaches a second number and the first number of target action instructions are the same instruction, wherein the first number does not exceed the second number; and
wherein the step of matching, from a pre-stored action instruction set, an action instruction according to the current emotional state and the keywords comprises a following step:
searching from cached corresponding relationships to judge whether a corresponding relationship hit by the keyword exists, wherein
if yes, an instruction recorded in a hit corresponding relationship is determined as the target action instruction; and
if no, the step of matching, from a pre-stored action instruction set, an action instruction according to the current emotional state and the keywords is executed again.

22. The live streaming control method according to claim 2, wherein for each action instruction in the pre-stored action instruction set, the live streaming device records a latest execution time of the action instruction; and
the step of executing the target action instruction comprises a following step:
obtaining a current time, and judging whether an interval between the current time and the latest execution time of the target action instruction exceeds a second preset duration, wherein
if the second preset duration is exceeded, the target action instruction is executed again; and
if the second preset duration is not exceeded, the pre-stored action instruction set is searched for other action instructions having an approximate relationship with the target action instruction, to replace the target action instruction, and a replaced target action instruction is executed.
